(19) United States
(12) Patent Application Publication
(10) Pub. No.: US 2013/0089833 A1
(43) Pub. Date: Apr. 11, 2013

(54) DENTAL TOOL AND METHOD FOR PRODUCING THE SAME

(71) Applicant: GEBR. BRASSELER GMBH & CO. KG, Lemgo (DE)

(72) Inventor: Juergen Schoen, Kalletal (DE)

(73) Assignee: GEBR. BRASSELER GMBH & CO. KG, Lemgo (DE)

(21) Appl. No.: 13/644,958

(22) Filed: Oct. 4, 2012

(30) Foreign Application Priority Data
Oct. 5, 2011 (DE) 10 2011 114 903.5

(51) Int. Cl. A61C 3/06; B24D 18/00

(52) U.S. Cl. 433/142; 51/295

(57) ABSTRACT

A dental tool includes a work area which is covered with abrasive particles, wherein the abrasive particles are embedded at least in part in a support layer formed galvanically on a surface of the work area, and wherein at least one cover layer which at least partly encloses the abrasive particles is arranged on the support layer, and to a method for producing the dental tool.

This application claims priority to German Patent Application 102011114903.5 filed Oct. 5, 2011, the entirety of which is incorporated by reference herein.

### DESCRIPTION

The present invention refers to a dental tool comprising a work area which is covered with abrasive particles. Such a dental tool is already known, for instance from DE 19825527A1.

Furthermore, the present invention refers to a method for producing the dental tool.

The abrasive particles, mostly diamond particles, are galvanically deposited/electrodeposited according to the prior art. The prepared work area which is mostly made up of a metallic material is arranged in a galvanic/electroplating bath which contains a mixture of abrasive particles and of the fluid needed for electrodeposition.

Normally, such dental tools, which are mostly used as grinding instruments, are covered with an electrodeposited nickel layer which partly encloses the abrasive particles and anchors them to the work area.

The dental tool may have very different configurations; it is normally a rotating instrument with a shaft that can be clamped in a drive device and the free end of which has arranged thereon a work head which forms the work area. However, it is also possible to produce non-rotating dental tools with this technology.

The drawback of the standard procedure is that the nickel layers may cause allergic reactions in a patient. That is why it is desired to produce a dental tool which is configured such that the patient does not get into contact with nickel materials and that there is thus no risk of allergies.

DE19825527A1 describes a dental instrument in which the support body is made of a nickel-free material and the fastening material for the abrasive particles also does not contain any nickel. Such a configuration cannot be used for every application, e.g. for reasons of material strength or also for reasons of costs.

Furthermore, it is known from the prior art that the abrasive particles are fixed in grinding tools by a solder bond. In this case, too, it turns out to be disadvantageous that the solder materials contain nickel.

It is the object of the present invention to provide a dental tool of the aforementioned type as well as a method for the production thereof which, while having a simple structure and being producible in a simple and inexpensive way, exhibit a high degree of operational safety and rule out the risk of nickel allergies.

According to the invention it is thus provided that the abrasive particles are embedded at least in part in a support layer formed galvanically on the surface of the work area, and that at least one cover layer which at least partly encloses the abrasive particles is arranged on the support layer.

According to the invention this yields a multilayered structure which provides plural layers on the work area of the dental tool. The support layer fixes and holds the galvanic/electrodeposited particles, particularly during the manufacturing method. It is called a support layer for the reason that it first holds and anchors the abrasive particles during their electrodeposition. Hence, it is possible, as is known from the prior art, to achieve a uniform and functional deposition of the abrasive particles, e.g. diamond particles.

According to the invention, a cover layer which completely covers the support layer and is therefore called a cover layer is provided as the second layer. The cover layer may have a greater thickness than the support layer, particularly for the reason that it anchors and fixes the abrasive particles. Hence, the cover layer fulfills an additional function, namely the binding and final holding of the abrasive particles.

Hence, the invention provides a dental tool in the case of which the abrasive particles are reliably held and fixed on the work area on the one hand and in the case of which any contact of the patient with the support layer is reliably prevented on the other hand.

Hence, according to the invention the support layer can also be made from a nickel-containing material as it is completely enclosed by the cover layer, without any risk for the patient.

The invention also refers to a method for producing a dental tool with a shaft and a work area secured thereto, the work area being covered at least in part with abrasive particles. The method according to the invention comprises the following work steps, which are preferably carried out in the indicated sequence, wherein some of the work steps can be carried out optionally.

Preferably, a blank of the dental tool, particularly of the work area, is first produced e.g. by a turning or grinding process. The blank surface is then activated for subsequent galvanic coating/electroplating. Such activation is preferably carried out by blasting, etching and/or electrolytic removal. This is particularly done in order to degrease the surface and/or to improve adhesion.

Subsequently, the abrasive particles are first attached, the particles being normally configured in the form of diamond grains. Attachment is carried out by forming a support layer. This process is carried out as galvanic coating from a nickel-sulfate or nickel-sulfamate electrolyte. Preferably, a nickel-sulfate electrolyte is used. The electrolyte temperature is here preferably 40° C. to 65° C. A temperature of 55° is particularly preferred. The current density is between 0.5 A/dm² and 5 A/dm², preferably 2 A/dm².

The time needed for attaching the abrasive particles (particularly diamond grains) depends here on the grain size of the abrasive particles. The grain size is defined as the average diameter of the individual abrasive particles. Since the thickness of the support layer is determined in response to the grain size of the abrasive particles, it is obvious that the time needed for galvanic attachment depends on the grain size. According to the invention the thickness of the support layer is chosen such that it is between 20% and 30% of the grain size (of the average diameter of the abrasive particles). A value of 25% is particularly advantageous.

It is made sure by way of the described procedure according to the invention that the abrasive particles are firmly anchored to the work area by the support layer.

During attachment of the abrasive particles, the abrasive particles are provided according to the invention in a suitable way. This may e.g. be done by spreading, but it is also possible to bury or immerse the blank in diamonds or a diamond package or to disperse the diamonds (abrasive particles) in the electrolyte solution, preferably by burying. It is thereby ensured that during electrolytic deposition of the support layer an adequate number of abrasive particles (diamonds) can be attached.

According to the invention, the cover layer is subsequently formed. This layer is preferably made from a material that is free of heavy metals, particularly from plastics, ceramics or a biocompatible metal, e.g. titanium. The cover layer can be applied according to the invention by spraying, dipping, powder coating, laser fusing and/or flame spraying.

In the dental tool to be produced, the overall layer thickness, which is the sum of the support layer and the cover layer, depends according to the invention on the grain size of the abrasive particles. It is preferably between 40% and 80% of the grain size of the abrasive particles, the average grain size being here preferably assumed. A value of 65% is particularly preferred for the overall layer thickness.

The thickness of the cover layer is produced according to the invention either such that the cover layer is applied in a targeted manner up to the desired thickness. In an alternative embodiment of the invention it is also possible to apply the cover layer with a greater thickness and thereby to completely fill or overfill the grain interspaces between the abrasive particles. This can be done up to a level of the grain tips of the abrasive particles. Subsequently, the excessively applied thickness of the cover layer is removed according to the invention up to preferably 65% of the grain size of the abrasive particles, the 65% referring to the above-mentioned overall layer thickness. The removing operation can be carried out mechanically, e.g. by brushing, blasting or by chemical or physical processes, for instance by etching, electrochemical removal, laser melting, chemical washing and/or photochemical removal.

Subsequently, some advantageous aspects of the invention will once again be discussed, reference being here made to the above description of the method steps.

According to the invention the cover layer can thus be made from at least a plastic material or from at least a metallic material or from at least a non-metallic material or from at least a ceramic material. According to the invention it is also possible to give the cover layer a multilayered configuration to improve the anchorage of the abrasive particles on the one hand and to optimize the wear properties on the other hand.

The application of a cover layer which is made of a plastic material turns out to be particularly advantageous since such a plastic layer can be provided with a colored design. It is thereby possible to mark the dental tool, so that other complicated identification approaches, such as color rings or laser markings, can be dispensed with. Likewise, a multilayered configuration of the cover layer, e.g., of plural plastic materials or also of plural other materials in a suitable combination is particularly advantageous because the user can obtain information about the wear condition through the wear of the respectively outer layer and the resulting color change (when differently colored layers are used).

According to the invention, the cover layer can be applied, as has been mentioned, when a plastic material is used, e.g. by way of a powder coating method or a powder painting method. Standard powder paints can be used which include dry grainy particles having a size between 1 μm and 108 μm. It is especially possible to use plastic materials that in the medical sector are approved and useable, e.g. PEEK. The powder is e.g. applied electrostatically. It is possible through a suitable configuration of the electric fields to avoid any undesired deposition on the abrasive particles, so that the cover layer can be formed on the support layer in an optimal way.

In an alternative configuration of the invention it is also possible to apply the cover layer by a PVD (physical vapor deposition) method. The material is here vaporized by bombardment with laser beams, magnetically deflected ions or electrons and supplied e.g. through electric fields at a negative pressure to the support layer to be deposited there. With such PVD methods it is possible to implement very low process temperatures, so that even low-melting plastics can be coated and processed, respectively.

According to the invention it is also possible to apply the cover layer by way of other method steps, e.g. by a dipping process. The thickness of the cover layer can e.g. be exactly set by a subsequent treatment with a brush or by spinning.

According to the invention it is particularly advantageous when the abrasive particles (diamond particles, grinding grains) are embedded up to ⅔ of the grinding grain or their thickness. Since the cover layer implements the binding process proper, it is advantageous when the particles are embedded up to ⅔ of their thickness in the cover layer, but it is also possible to arrange them up to ⅔ of their thickness in the cover layer and in the support layer. As has been described, the support layer substantially only serves to fix the abrasive particles and thus it has a thickness which is relatively small in comparison with the cover layer. The particles can e.g. have a grain size of 100 μm, at a thickness of the layers of 65 μm. Therefore, the particles can be accommodated e.g. up to ⅓ of their embedment depth in the support layer and up to ⅔ of their embedment depth in the cover layer.

As an alternative to the above-described possibility of applying the cover layer, other variants follow according to the invention; for instance, it is also possible to apply the cover layer by a CVD (chemical vapor deposition) method.

As has been mentioned, the cover layer may be made of different materials which, on the one hand, ensure a chemical insulation of the support layer positioned underneath the cover layer and, on the other hand, effect adequate anchoring and binding of the abrasive particles. As has been mentioned, it is also possible to use very different materials in a cover layer having a multilayered structure.

The dental tool according to the invention can e.g. be configured as a grinder. It is possible to offer it for single use in a sterile packaging, so that there is no risk that the patient gets into contact with the nickel-containing support layer due to wear of the cover layer. Depending on the intended application, the configuration of the dental tool and the material selection for the cover layer, it is however also possible to create a dental tool for multiple use.

The invention will now be described with reference to an embodiment taken in conjunction with the drawing, in which:

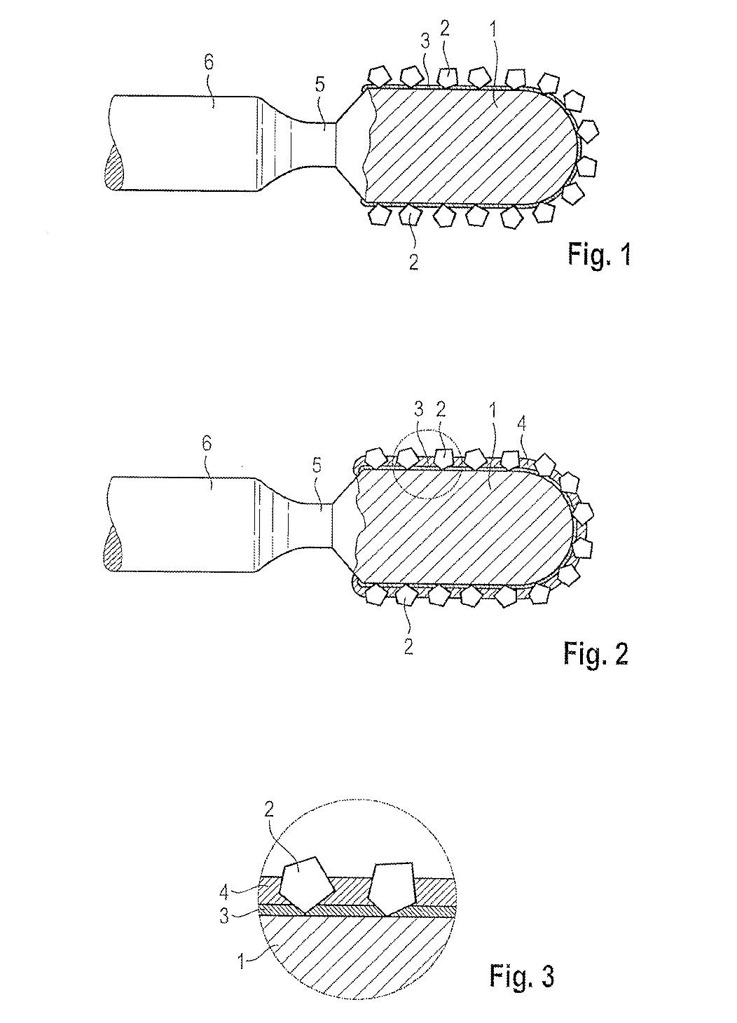

FIG. 1 is a schematic illustration of an embodiment of a dental tool according to the invention in a first manufacturing process;

FIG. 2 is an illustration according to FIG. 1 in the finished state; and

FIG. 3 is an enlarged illustration according to FIG. 2.

The dental tool shown in FIGS. 1 and 2 includes a work area 1, which is schematically shown in a sectional view. The work area 1 is provided via a neck 5 with a shaft 6 which can be clamped in a rotating drive, as is known from the prior art.

In a first manufacturing step, a support layer 3 is applied by a galvanic process to the mechanically prepared base body of the dental tool. Owing to this galvanic process, a coating process with abrasive particles 2 is simultaneously carried out with the support layer 3, as is known from the prior art. As shown in FIG. 1, the support layer 3 is made very thin in the dental tool according to the invention and its thickness is dimensioned such that it just fixes the abrasive particles 2, so that these are available for the subsequent manufacturing process.

FIG. 2 shows the finished dental tool in which, starting from the state shown in FIG. 1, the support layer 3 has applied thereto a cover layer 4 which is much thicker than the support layer 3 and binds and anchors the abrasive particles 2. The abrasive particles 2 are here e.g. embedded up to ⅔ of their thickness in the cover layer 4. Furthermore, FIG. 2 shows that the cover layer 4 fully encloses the carrier layer 3, thereby chemically insulating the support layer 3. FIG. 3 shows an enlarged detail view.

### LIST OF REFERENCE NUMERALS

1 Work area
2 Abrasive particles
3 Support layer
4 Cover layer
5 Neck
6 Shaft

1. A dental tool comprising:
a work area;
a support layer formed galvanically on a surface of the work area;
abrasive particles embedded at least in part in the support layer, and
at least one cover layer arranged on the support layer which at least partly encloses the abrasive particles.

2. The dental tool according to claim 1, wherein the cover layer is made from at least one of a plastic material, a metallic material, a non-metallic material, and a ceramic material.

3. The dental tool according to claim 2, wherein the support layer pre-fixes the abrasive particles during a first manufacturing step while the abrasive particles are anchored by the support layer to the work area.

4. The dental tool according to claim 3, wherein the abrasive particles are substantially arranged up to ⅔ of their thickness in the support layer and in the cover layer.

5. The dental tool according to claim 4, wherein the cover layer is colored.

6. The dental tool according to claim 5, wherein the cover layer is produced by applying a liquid or powder-like mass, by at least one of spraying, dipping, powder coating, a PVD method and a CVD method.

7. The dental tool according to claim 4, characterized in that the cover layer covers the whole support layer in a chemically insulating manner.

8. The dental tool according to claim 1, wherein the support layer pre-fixes the abrasive particles during a first manufacturing step while the abrasive particles are anchored by the cover layer to the work area, the abrasive particles are embedded substantially up to 213 of their thickness in the cover layer, and the cover layer covers the whole support layer in a chemically insulating manner.

9. A method for producing a work area of a dental tool which is covered with abrasive particles, comprising:
providing a metallic blank of the work area,
applying abrasive particles to the work area by at least one of spreading, burying and dispersing onto the work area,
applying a support layer for supporting the abrasive particles by galvanic coating in a nickel-sulfate or nickel-sulfamate electrolyte at an electrolyte temperature between 40° C. and 65° C., at a current density of 0.5 A/dm² to 5 A/dm²,
subsequently applying a cover layer over the support layer and abrasive particles.

10. The method according to claim 9, wherein the support layer is produced at a thickness of 20% to 30% of an average diameter of the abrasive particles.

11. The method according to claim 10, wherein the support layer and the cover layer together are produced at a thickness of 40% to 80% of the average diameter of the abrasive particles.

12. The method according to claim 11, comprising applying the cover layer in one work step up to the desired thickness.

13. The method according to claim 11, comprising applying the cover layer by overfilling interspaces of the abrasive particles up to a level of grain tips of the abrasive particles, and subsequently removing cover layer up to 65% of the average diameter of the abrasive particles, wherein the removing operation is carried out by at least one of brushing, blasting, etching, electrochemical removal, laser melting, chemical washing and photochemical removal.

14. The method according to claim 11, wherein prior to applying the support layer, the blank is at least one of blasted, etched, electrolytically pretreated, and degreased.

15. The method according to claim 9, wherein the cover layer is made from a material that is free of heavy metals, from at least one of plastics, ceramics, biocompatible material, and titanium.

16. The method according to claim 9, wherein the cover layer is applied by at least one of spraying, dipping, powder coating, laser fusing and flame spraying.

17. The method according to claim 9, wherein the galvanic coating is performed at an electrolyte temperature of approximately 55° C. and at a current density of approximately 2 A/dm².

18. The method according to claim 10, wherein the support layer is produced at a thickness of approximately 25% of the average diameter of the abrasive particles.

19. The method according to claim 11, wherein the support layer and the cover layer together are produced at a thickness of approximately 65% of the average diameter of the abrasive particles.

20. The method according to claim 9, wherein applying the abrasive particles and applying the support layer is performed simultaneously.
